(19) United States
(12) Patent Application Publication
(10) Pub. No.: US 2006/0230946 A1
(43) Pub. Date: Oct. 19, 2006

(54) Method And Device For Making Coffee

(76) Inventor: Yun-Chung Cheng, Taipei (TW)

Correspondence Address: LIN & ASSOCIATES INTELLECTUAL PROPERTY, P.O. BOX 2339, SARATOGA, CA, 95070-0339, US

(21) Appl. No.: 11/278,828

(22) Filed: Apr. 6, 2006

(30) Foreign Application Priority Data
Apr. 13, 2005 (TW) 094111660

(51) Int. Cl. A47J 31/057

(52) U.S. Cl. 99/300

(57) ABSTRACT

A method and a device implementing the method for making coffee are provided herein. The method and the related device use pressurized air as a media for pushing water under uniform pressure to flow through the coffee cake such that high-quality crema will be formed. The method basically contains the following steps. First, a water tank partially filled with hot water is provided. Then, high pressure air is filled and maintained within the water tank without releasing. A check valve leading to the coffee cake is then opened and the hot water is pushed by the high-pressure air to flow through the check valve and coffee cake. The temperature of the hot water is between 80˜100° C., and the amount of water is between one to two thirds of the volume of the water tank. The pressure level of the high-pressure air is between 6˜10 atm.

### BACKGROUND OF THE INVENTION

1. Field of the Invention

The present invention relates to a method of making coffee and the device implementing the coffee making method, and more particularly to a method and device using pressurized air to force hot water to flow through a coffee cake.

2. The Prior Arts

In general, Espresso is a type of coffee made by placing coffee grounds in a filtering container, pressing the coffee grounds by a tamper into a coffee cake, and then pressurizing hot water to flow through the coffee cake.

Because coffee beans contain large quantity of carbon dioxide, under appropriate temperature and pressure, brown foams, the so-called crema, will be produced. In the ideal case, Espresso should be like a paste with the brown crema on top, instead of a black liquid. The crema's foams should be fine and the surface should be as smooth as a mirror. The crema is formed from the thin films produced by the active agents contained in the coffee beans and, within the thin films, a lot of tiny carbon dioxide and vapor bubbles are enclosed. Therefore the special aura of coffee beans is preserved inside. As such, the quality of Espresso can be determined by examining the presence and the appearance of the crema.

Normally, there are two types of devices to make Espresso, one is the Mocca pot and the other is the electric coffee maker. The Mocca pot uses non-pressurized boiled water and there is usually no crema formed due to inadequate pressure and the temperature being too high. The electric coffee maker, as shown in FIG. 1, includes a container 10, a water tank 20 having a first check valve 21 extending into the container 10, and a pressurized water supply device 30. It is noted from the drawing that the first check valve 21 is on top of the coffee cake C inside the container 10. The pressurized water supply device 30 is connected to the water tank 20 via a pipe 32. The pressurized water supply device 30 further contains a water pump 31 to pump water 40 though the pipe 32 into the water tank 20. To make Espresso, the water 50 inside the water tank 20 is heated to a predetermined temperature, the pressurized water 40 in the pipe 32 is controlled to flow into the water tank 20 so as to force the hot water 50 to flow through the first check valve 21, the coffee cake C, and the filter 11 at the bottom of the container 10.

However, when the room-temperature pressurized water 40 in the pipe 32 flow into the water tank 20, the temperature of the hot water 50 in the water tank 20 drops and the quality of the Espresso is affected. Although increasing the capacity of the water tank 20 would reduce the impact of mixing room-temperature water 40 with hot water 50, the cost of the product and the electricity cost in heating larger amount of water would be significantly increased. Furthermore, in order to maintain the high pressure to the water 40, the water pump 31 has to be kept running during the coffee making process. Due to the incompressibility of water, the vibration of the water pump 31 will be delivered to the hot water 50, causing the pressure of the hot water 50 on the coffee cake C to be varied, which results in scarce and coarse crema. Using a more expensive but less vibrating rotary motor could lessen the above problem, but only to a limited extent.

### SUMMARY OF THE INVENTION

Due to the incompressibility of water, using water pump to pressurize and push water through coffee cake inevitably delivers the vibration of the water pump to the pressurized water, producing Espresso of interior quality. The present invention therefore provides a method using pressurized air as a media for pushing water under uniform pressure to flow through the coffee cake such that high-quality crema will be formed.

The method basically contains the following steps. First, a water tank partially filled with hot water is provided. Then, high pressure air is filled and maintained within the water tank without releasing. A check valve leading to the coffee cake is then opened and the hot water is pushed by the high-pressure air to flow through the check valve and coffee cake. The temperature of the hot water is between 80˜100° C., and the amount of water is between one to two thirds of the volume of the water tank. The pressure level of the high-pressure air is between 6˜10 atm.

As the hot water is driven by the expansion of the high-pressure air, instead of by the pressure exerted by a water pump, there is no non-uniform pressure problem as found in the prior arts. On the other hand, as the mass and the specific heat ratio of air are much lower than that of the room-temperature water used in prior arts, the driving exerted by the high-pressure air does not affect the temperature of the hot water. In other words, with the present invention, the pressure and temperature of Espresso making process can be precisely controlled so as to produce high-quality coffee.

The foregoing method can be implemented in a device proposed by the present invention. In one embodiment, the device contains a water tank, a container installed below the water tank for holding the coffee cake, a water supply device, and an air pressurized device. The water tank has a first check valve at the bottom leading to the container. The water supply device contains a first water pump connected to the water tank via a first water pipe and a second check valve. The air pressurized device contains an air tank connected to the water tank via a second air pipe and a fourth check valve, an air pump connected the air tank via a first air pipe and a fifth check valve. The water tank also has a third check valve for releasing air pressure from the water tank.

In making Espresso with the device, the first water pump of the water supply device will automatically fill the water tank up to a predetermined amount of water via the first water pipe and the second check valve. The second check valve is then closed and the water is heated to a predetermined temperature. On the other hand, the air pump compresses air into the air tank via the first air pipe and the fifth check valve. When the pressure inside the air tank and the second air pipe reach a predetermined level, the fifth check valve is closed. To start making Espresso, the first and fourth check valves are opened. The high-pressure air from the air tank expands into the buffer space of the water tank, and further pushes the hot water inside to flow through the first check valve and the coffee cake. High-quality Espresso is therefore produced.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1 is a schematic view showing a conventional coffee maker;

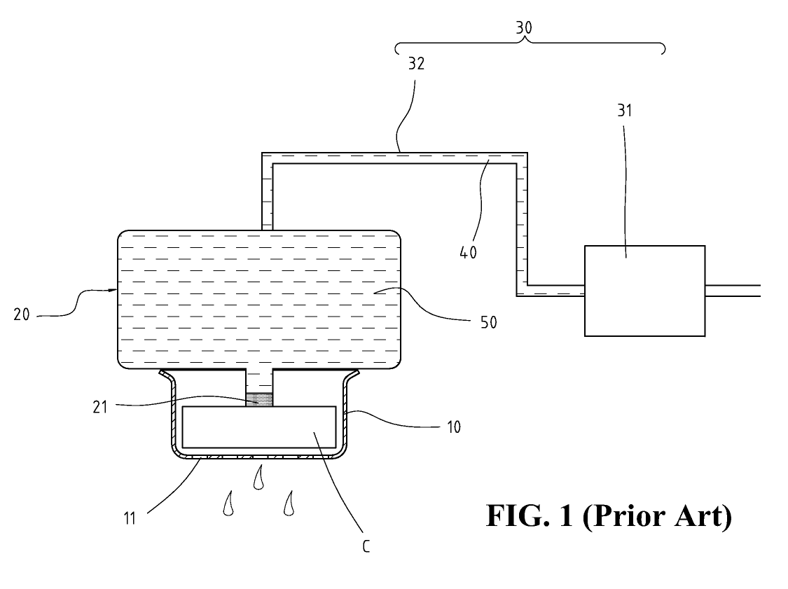

FIG. 2 is a schematic view showing a coffee maker according to an embodiment of the present invention; and

FIG. 3 is a schematic view showing a coffee maker according to another embodiment of the present invention.

### DETAILED DESCRIPTION OF PREFERRED EMBODIMENT

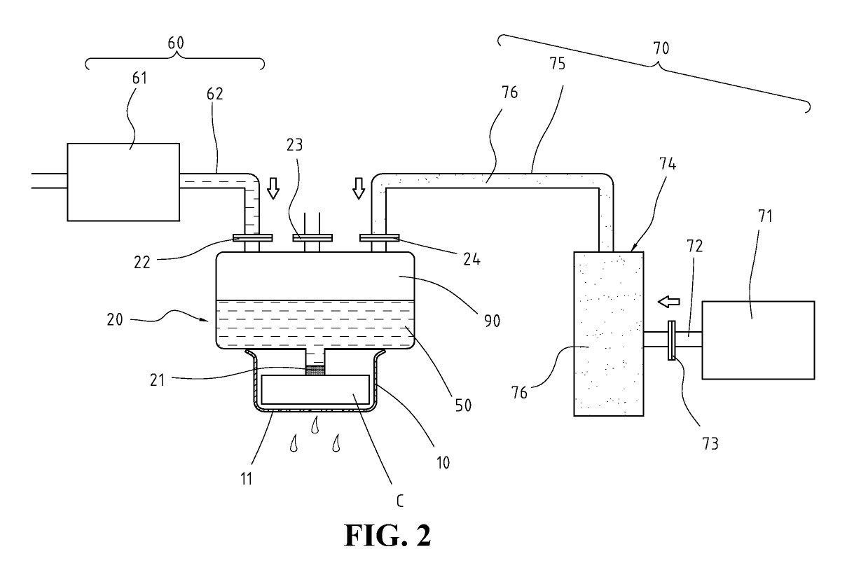

With reference to FIG. 2, a coffee maker according to an embodiment of the present invention includes a container 10, a water tank 20, a water supply device 60 and an air pressurized device 70.

Coffee grounds are placed inside the container 10 and pressed to become a coffee cake C. The container 10 is then installed to the bottom of the water tank 20. The container 10 has a filter 11 at bottom allowing coffee to be filtered through. The water tank 20 has a first check valve 21 extending into the container 10. The first check valve 21 is an electromagnetic valve or a valve of any other appropriate style.

The water tank 20 further has a second check valve 22, a third check valve 23, and a fourth check valve 24 on the top. Each of the check valves is an electromagnetic valve or a valve of any other appropriate style. The second and fourth check valves 22 and 22 are single-direction (as shown in the diagram) back-pressure valves, and the third check valves 23 is a pressure-releasing valve for releasing air pressure inside the water tank 20. The water supply device 60 includes a first water pump 61 and a first water pipe 62 extending from the first water pump 61 to the water tank 20 via the second check valve 22. The air pressurized device 70 includes an air pump 71, an air tank 74, a first air pipe 72 extending from the air pump 71 to the air tank 74 with a fifth check valve 73 therebetween, and a second air pipe 75 extending from the air tank 74 to the water tank 20 via the fourth check valve 24. The fifth check valve 73 is also a single-direction (as shown in the diagram) back-pressure value, which can be an electromagnetic one or one of any other appropriate style.

To make Espresso, the third check valve 23 is first opened to release the high pressure inside the water tank 20 resulted from the previous coffee making process. After the air pressure inside the water tank 20 returns to a normal pressure, the third check valve 23 is sealed again. Before a new coffee making process is started, the water level in the water tank 20 will be detected. If the water level is below a threshold, the first water pump 61 will be automatically engaged and the second check valve 22 will be opened to fill the water tank 20 via the first water pipe 62 until the water in the water tank 20 reaches a certain amount. Basically, the amount of water inside the water tank 20 should be at least equal to what is required to make coffee from the coffee cake C. Generally, the amount of water is usually at least one third of the volume of the water tank 20, and not filling up the entire water tank 20 so as to leave some space for buffering high-pressure air. Without this buffer, when the high-pressure air is provided to the water tank 20, the pressure will be delivered to the coffee cake C immediately, therefore breaking up the coffee cake into pieces. This will result in less amount of crema. Considering the adequate amount of water and the buffer required, the maximum amount of water should be at most two third (⅔) of the volume of the water tank 20, with one half (½) of the volume of the water tank 20 being the ideal amount.

Then, after the water inside the water tank 20 reaches a predetermined level, the water is heated to a predetermined temperature (preferably 80˜100° C.). The temperature can be adjusted based on a number of factors such as the types of coffee beans, personal preference, and environment temperature. Generally, the temperature is a few degrees above or below 90° C., with 90° C. being the ideal temperature.

Then, the air pump 71 is engaged to drive air into air tank 74 and the second air pipe 75 via the first air pipe 72 and the fifth check valve 73. When the pressure inside the air tank 74 and second air pipe 75 reach a required level, the air pump 71 and the fifth check valve 73 are shut off and closed. At this point of time, the air tank 74 and the second air pipe 75 are full of high-pressure air 76. The pressure level is usually between 6˜10 atm and can be adjusted in accordance with the capacity of the water tank 20, the type of coffee beans, etc. Preferably, it is controlled to be within 7˜9 atm, with 9 atm being the ideal level.

After the water and the air pressure are ready, the first check valve 21 and the fourth check valve 24 are opened. The high-pressure air 76 in the second air pipe 75 and the air tank 74 quickly expands into the buffer space 90 in the water tank 20. The pressure of the high-pressure air 76 is thereby balanced and decreased as it enters the buffer space 90. As the buffer space 90 is smaller than the capacity of the second air pipe 75 and the air tank 74, the extent of pressure loss is limited. In order to compensate the pressure loss, the pressure from the air pump 71 can be increased based on some calculation to make up the pressure loss, so that the balanced pressure is exactly what is required. As the pressure reaches a balanced state between the buffer space 90 and the second air pipe 75 as well as the air tank 74, the high-pressure air 76 forces the hot water 50 to flow through the fist check valve 21, the coffee cake C, and the filter 11 of the container 10. Because the mass and specific heat ratio of air is much smaller than those of the liquid, influence from the high-pressure air 76 to the temperature of the hot water 50 is little, which effectively overcomes the prior art drawback. Furthermore, the pressing of the hot water 50 is achieved by the expansion of the high-pressure air 76, not by some pressurizing pump. Therefore, there is no vibration and the pressure on the hot water 50 is uniform, which, again, effectively resolves the drawbacks of prior arts. Based on the foregoing description, the present embodiment can indeed precisely control the temperature and pressure in making Espresso and delivers coffee of finest quality and taste.

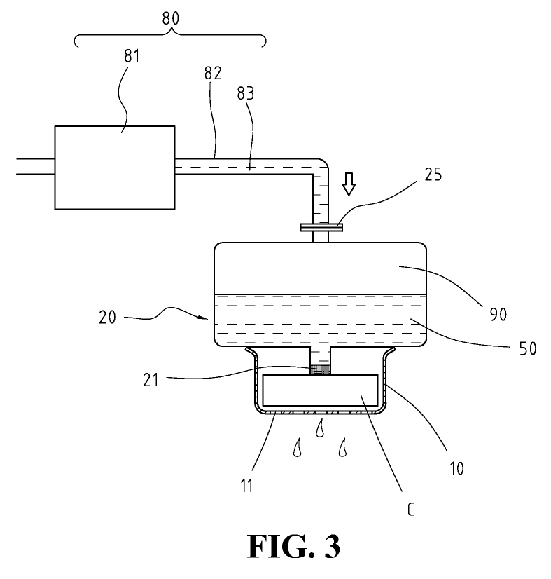

With reference to FIG. 3, a coffee maker according to another embodiment of the present invention includes a container 10, a water tank 20, and a pressurized water supply device 80 replacing the water supply device 60 and the air pressurized device 70 of the previous embodiment.

Coffee grounds are placed inside the container 10 and pressed to become a coffee cake C. The container 10 is then installed to the bottom of the water tank 20. The container 10 has a filter 11 at bottom allowing coffee to be filtered through. The water tank 20 has a first check valve 21 extending into the container 10. The water tank 20 further has a sixth check valve 26 on the top, which is a single-direction (as shown in the diagram) back-pressure valve. The sixth check valve 25 can be an electromagnetic valve or a valve of any other appropriate style. The pressurized water supply device 80 includes a second water pump 81 and a second water pipe 82 extending from the second water pump 81 to the water tank 20 via the sixth check valve 25. The second water pump 81 pressurizes the water in the second water pipe 82 into high-pressure water 83 whose pressure is around 10˜13 atm.

The water tank 20 is filled in advance with high-pressure air. As there is no pressure releasing valve and the sixth check valve 25 is unidirectional, the high-pressure air will be maintained in the buffer space 90 of the water tank 20. Therefore, the interior of the water tank 20 remains in a high-pressure condition. The pressure level of the high-pressure air is usually between 6˜10 atm and can be adjusted in accordance with the capacity of the water tank 20, the type of coffee beans, etc. Preferably, it is set between 7˜9 atm, with 9 atm being the ideal level.

Before a new coffee making process is started, the water level in the water tank 20 will be detected. If the water level is below a threshold, the sixth check valve 25 is opened and the high-pressure water 83, whose pressure level is higher than that of the high-pressure air inside the water tank 20, will fill the water tank 20 via the second water pipe 82 until the water in the water tank 20 reaches a certain amount. Basically, the amount of water inside the water tank 20 should be at least equal to what is required to make coffee from the coffee cake C. Generally, the amount of water is usually at least one third of the volume of the water tank 20, and not filling up the entire water tank 20 so as to leave the buffer space 90. Considering the adequate amount of water and the buffer required, the maximum amount of water should be at most two third (⅔) of the volume of the water tank 20, with one half (½) of the volume of the water tank 20 being the ideal case.

Then, after the water inside the water tank 20 reaches a predetermined level, the sixth check valve 25 is closed and the water is heated to a predetermined temperature (preferably 80˜100° C.). The temperature can be adjusted based on a number of factors such as the types of coffee beans, personal preference, and environment temperature. Generally, the temperature is a few degrees above or blow 90° C., with 90° C. being the ideal temperature.

After the water is ready, the first check valve 21 is opened. The hot water 50 is forced by the high-pressure air in the buffer space 90 to flow though the first check valve 21, the coffee cake C, and the filter 11 of the container 10. Again, the driving to the hot water 50 is achieved by the expansion of the high-pressure air, not by some pressurizing pump. Therefore, there is no vibration and the pressure on the hot water 50 is uniform, which effectively resolves the drawbacks of prior arts. Based on the foregoing description, the present embodiment can indeed precisely control the temperature and pressure in making Espresso and delivers coffee of finest quality and taste.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A method for making coffee comprising the steps of:
providing a water tank partially filled with hot water of an appropriate temperature;
preserving pressurized air of an appropriate pressure level within the space not occupied by said hot water in said water tank;
opening a valve of said water tank leading to a filtering container and thereby allowing said pressurized air to push said hot water in said water tank to flow through said valve and a coffee cake received in said filtering container.

2. The method as claimed in claim 1, wherein said appropriate temperature of said hot water is between 80˜100° C.

3. The method as claimed in claim 1, wherein the amount of said hot water is between one to two thirds of the volume of said water tank.

4. The method as claimed in claim 1, wherein said appropriate pressure level of said pressurized air is between 6˜10 atm.

5. A coffee maker comprising:
a filtering container for receiving a coffee cake;
a water tank having a first check valve leading to said filtering container, a second check valve, a third check for releasing air pressure from said water tank, and a fourth check valve;
a water supply device having a first water pump and a first water pipe extending from said first water pump to said water tank via said second check valve;
an air pressurized device having an air tank, a second air pipe extending from said air tank to said water tank via said fourth check valve, an air pump, and a first air pipe extending from said air pump to said air tank with a fifth check valve therebetween.

6. A coffee maker comprising:
a filtering container for receiving a coffee cake;
a water tank having a first check valve leading to said filtering container, and a sixth check valve, said water tank being filled with high-pressure air of an appropriate amount;
a pressurized water supply device having a second water pump and a second water pipe extending from said second water pump to said water tank via said sixth check valve.
